(19) United States
(12) Patent Application Publication
(10) Pub. No.: US 2005/0000952 A1
(43) Pub. Date: Jan. 6, 2005

(54) Focusless micromachining

(76) Inventor: Donald J. Harter, Ann Arbor, MI (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/848,746

(22) Filed: May 19, 2004

Related U.S. Application Data
(60) Provisional application No. 60/471,550, filed on May 19, 2003.

(51) Int. Cl. B23K 26/36; B23K 26/06

(52) U.S. Cl. 219/121.68; 219/121.69; 219/121.73

(57) ABSTRACT

A system for ablating solid material, which comprises of a laser generating ultra short pulses. The pulses are generated in a medium which conducts the ultra short pulses toward the solid material. The ultra short pulses self focus in the medium to a power sufficient to ablate said solid material.

This application is a nonprovisional application of pending U.S. provisional application No. 60/471,550, filed May 19, 2003.

### BACKGROUND OF THE INVENTION

1. Field of the Invention

The present invention relates to utilizing self-focusing of laser beams while modifying the properties of materials. In this invention self-trapping and/or self-focusing condition the laser beam before it reaches the surface of a material to be modified. Self-focusing and self-trapping removes structure on the spatial profile of the laser and removes low power satellite pulses that come before or after the main pulse. The self-trapping and self-focusing in the propagation material can determine the pulse peak power and spot size that reaches the material to be modified.

2. Description of the Related Art

The laser has become a well-regarded industrial tool for material processing particularly in the fields of automotive manufacturing, electronic fabrication and medicine. The most common functions for the laser in material processing are cutting, welding, and drilling. In each of these operations the laser beam needs to be focused in order to create a small spot at the point of interaction between the laser radiation and the material. Creating the small spot concentrates the light power to maximize its effect on the material. The light is also focused when small features are desired for the interaction of the material and the light. This type of laser material processing is called laser micromachining. Laser micromachining is machining where feature sizes less than 100 μm are desired. A lens, diffractive element or a holographic element typically focuses the laser beam. The spot size of the focused spot is determined by diffraction and it is diffraction that causes the beam not to remain a small spot. Therefore the material to be processed must be positioned so the distance from the focusing element is such that the focus spot is where the interaction is desired. The distance over which the spot stays focused is called the Rayleigh length that is:
D=πω²/λ
where ω is the spot radius and λ is the wavelength of light. For example when the beam from a laser emitting radiation at 1.064 μm is focused to a 5 μm spot radius the spot will stay this size for about 74 μm. Thus the position of the material from the focusing element needs to be to this accuracy. This may not be easy. For example, ablating the surface of a material that has a very rough or irregular surface could be difficult with this critical dimension. However, under certain conditions a laser beam can remain small over long distances by self-trapping or a moving foci. It is the purpose of this invention to utilize this ability.

Self-focusing is a nonlinear phenomenon that has been studied for about 40 years. It is the phenomenon that normally limits the pulse energies from solid-state lasers due to catastrophic damage to the laser's gain crystal. Self-focusing is an induced lens effect. It is caused by a laser beam with a finite diameter propagating in a nonlinear medium with a refractive index n=nₒ+n₂ I. Where nₒ is a constant refractive index component, n₂ is a refractive index component which varies with light intensity, and I is the beam intensity. A laser beam where the intensity is highest in the center will see a higher refractive index in the center compared to the edges of the beam. This is much like a lens with a glass that is thicker in the center and the glass having a higher index than the surrounding air. Thus the beam is focused. It would be expected that the beam would continue to get smaller and smaller but typically there is a limit on how much the refractive index can change. At this point self-focusing and diffraction reaches equilibrium and the beam can continue to propagate as a focused beam for a long distance. Once the beam reaches this equilibrium state it is often called self-trapped.

Self-focusing and self-trapping of a laser beam was first predicted in 1966 (Javan and Kelly, “Possibility of Self-Focusing Due to Intensity Dependent Anomalous Dispersion,” IEEE Journal of Quantum Electron., QE-2, pp. 470-473, 1966, which reference is hereby incorporated herein by reference as though copied verbatim herein). Their treatment predicts that an unfocused light beam initially of diameter d will be brought to a focus in a distance on the order of z_{f}=d (nₒ/16 δn)^{1/2}.

Where δn=n₂ I, the intensity induced change in refractive index. Their analysis predicts the possibility of self-trapping the light beam when the beams divergence due to diffraction is balanced by the focusing effect of the nonlinear refractive index. If the diffraction half-angle [˜1.22λ/2 nₒ d] is equal to the critical angle for total internal reflection [˜(2δn/nₒ)^{1/2}], then the diameter D of the filament corresponds to the minimum possible diameter for self-trapping which is given by Dₘᵢₙ=1.22λ (8 nₒδnₘₐₓ)^{-1/2}.

Another interesting phenomena is that the laser power in the filament can be found from the equation for D with δn=n₂ I and P=πD² I/4. It is P_{cr}=π (0.61 λ)²/(8 nₒ n₂). This power does not depend on the diameter of the laser. This is the critical power for starting a self-focused filament and will be the power that ends up in the filament. Thus there are several interesting phenomena combined in the invention to allow micromachining. One is the laser beam needs not to be focused. Another is once the self-trapped filament reaches equilibrium then the spot size remains constant. There is no focus. Also, the spot size and intensity in the filament are fixed by parameters of the material in front of the surface of interest.

Most of the early work in understanding self-trapping was performed in atomic vapors such as sodium or potassium where the laser was tuned close to some resonance. These materials are well suited for these studies since the atomic resonance's are strong and varying the temperature of the material can easily change the densities of the material. The resonance is also well isolated from other resonance's so the interaction can fit the model of a laser interacting with a two-level atom. The beam of a cw laser was shown to funnel into a self-trapped filament in Bjorkholm, Phys. Rev. Lett., Vol. 32, 129, 1974, which reference is hereby incorporated herein by reference as though copied verbatim herein, when the laser is tuned close to a resonance in a sodium atomic vapor. The inventor (Harter) has also done careful studies of self-trapped filaments when a nanosecond pulse laser is tuned close to a resonance in a Sodium atomic vapor (D. J. Harter, Ph.D. thesis, University of Rochester, Rochester, N.Y., 1982, which reference is hereby incorporated herein by reference as though copied verbatim herein). In these cases self-trapped filaments follow the equations above quite closely. Stable filaments are created because the refractive index of the transition can be completely saturated by the laser power in the self-focused beam. δnₘₐₓ is a well-defined number and Dₘᵢₙ of the filament follows the equation above. It does take power out of the laser beam to saturate the transition so the propagation in the filament is lossy. However, the atomic vapor is very dilute and is nearly a vacuum so the loss for saturating the transition is small compared to the length of the interaction.

For self-focusing in liquids and solids the situation is quite different from atomic vapors. Since the laser is not tuned close to a resonance in liquids and solids, the power that would be required to saturate the transition is not attainable in a self-focused beam. Also, if the transition was saturated the loss to the laser would be extremely high that there would not be any propagation of the laser in the material. However, there does appear to be self-focusing that leads to self-trapped filaments in solids and liquids. Shen has an alternative explanation for these observed filaments in solids and filaments with longer pulse widths (˜>10 ps). This is now the more accepted explanation. A review of his work is given in Shen, “The Principles of Nonlinear Optics,” John Wiley & Sons, New York, 1984, chapter 17, which reference is hereby incorporated herein by reference as though copied verbatim herein. The concept is that the pulse does not focus to a self-trapped filament, but that the different temporal parts of the pulse focus to different places along the axis to give the appearance of a self-trapped filament with constant diameter and constant power. However, the temporal shape is different along the focus. Other nonlinear processes in the material such as Stimulated Raman and Brilluoin scattering limit the diameter and power. As far as micromachining is concerned it is not important if the constant size spot and power is generated by self-trapped filament or by the moving focus.

More recently there has been the demonstration of self-trapped filaments in air. In 1994, it was shown that self-trapped filaments could be propagated for tens of meters. (A. Braun et al., “Self-channeling of high-peak-power femtosecond laser pulses in air,” Opt. Lett. 20, pp. 73-75, 1995, which reference is hereby incorporated herein by reference as though copied verbatim herein). This work has been more recent since the self-trapping requires mJ pulse energies with femtosecond range pulse durations. These pulse properties have not been readily available earlier. It is interesting to note that these are the pulse properties that are considered for femtosecond micromachining. Even this pulse still can not saturate the refractive index of air. However, another mechanism takes place that stabilizes the filaments. The ionization of the air creates a negative focusing that balances self-focusing. This balance limits the power and size of the filament.

It has been predicted (Harter p. 124.) that the self-trapped filaments in atomic vapor saturating nonlinear index could be quite close to being solitons in the spatial extent. This has been an active area of research recently and this area of research is reviewed in Segev, “Self-trapping of optical beams: spatial solutions,” Physics Today, pp. 42-48, August 1998, which reference is hereby incorporated herein by reference as though copied verbatim herein. In this invention, we focus on the use of the nonlinearity that is proportional with the power of the laser pulse. However the other forms of optical nonlinearity that are discussed in this reference for forming spatial solitons can also be used in this invention. They include the use of thermal and photorefractive nonlinearities.

Self-trapping and self-focusing of optical beams has been suggested for material processing in U.S. Pat. Nos. 6,387,593 and 4,943,700. In both of these cases the laser beam is being focused on the surface of the material and then self-trapping is taking place in the material that is being modified. In this invention self-trapping and self-focusing in the propagation material before reaching the material to be modified is being utilized. The purpose of the self-trapping and self-focusing is conditioning the laser beam before the material to be modified. Self-trapping and self-focusing is not expected in the material that is to be modified by the pulse. In U.S. Pat. No. 6,387,593 the self-trapped filament is formed over seconds to minutes from the change in index by photopolymerization. This is a permanent change in the refractive index unlike the change of refractive index described here. In U.S. Pat. No. 4,943,700 the self-trapped filament is formed in the material being cut including opaque materials such as wood, rocks ceramics and metals. From the literature, self-trapping has not been reported in such materials. However, the pulse energy in U.S. Pat. No. 4,943,700 is six to twelve orders of magnitude higher than is used in micromachining so other physics may be possible.

In 1971, Charles Townes patented the concept of using self-trapped filaments to propagate pulses for micromachining. In this patent, the inventors do not consider atomic vapors as the nonlinear material. In this patent, the inventors cover self-trapped filaments in solids and liquids. In this patent, the inventors also cover self-trapped filaments in air. However, self-trapping in air was not observed until the experiments in 1994 by Gerard Mourou's group. Self-trapping in air was not feasible until high-energy femtosecond lasers became available in the 1990's. The lasers described in U.S. Pat. No. 3,571,555 have a pulse widths that are nanosecond or longer. These were the shortest pulses available for laser machining when this document was submitted to the PTO in 1965. Mode locking had been discovered in 1964 and pulses with sub nanosecond pulse widths (>100 ps) with sufficient energy for self-trapping were not discovered until 1966.

### SUMMARY OF THE INVENTION

The object of this invention is to utilize the unique properties of self-focusing and self-trapping in the field of laser micromachining. The unique properties are that the laser beam does not need to be focused to give a small spot size. A small spot size is maintained over a long distance. This means the Rayleigh range does not limit the distance over where the spot size remains small. The pulse energy and the spot size are not determined by the laser but by the properties of the material that is in front of the material of the object to be micromachined. Thus laser instability does not affect the quality of the micromachining. It is not required for self-trapped filaments to be formed for benefit from self-focusing. The self-focusing process can remove pedestals and satellite pulses from the pulse. It is the further object of this invention to describe how self-focusing and self-trapping can be used for a practical micromachining system.

### BRIEF DESCRIPTION OF THE DRAWINGS

FIG. 1. State of the art for laser micromachining a rough surface. The material is translated perpendicular to the beam for machining an area of the material. The material must be translated parallel to the laser beam in order to keep the material surface at the focus point.

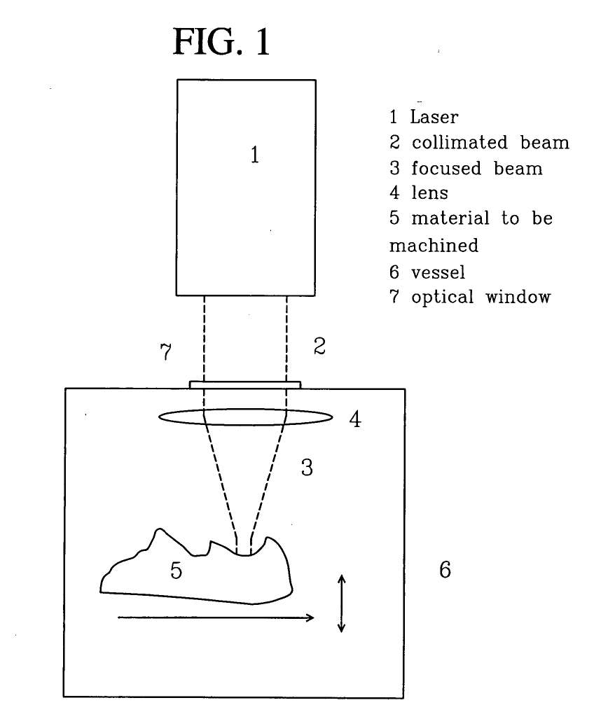

FIG. 2. Laser micromachining a rough surface with a self-trapped filament. The self-trapped filament is formed before the material to be modified in a nonlinear optical material.

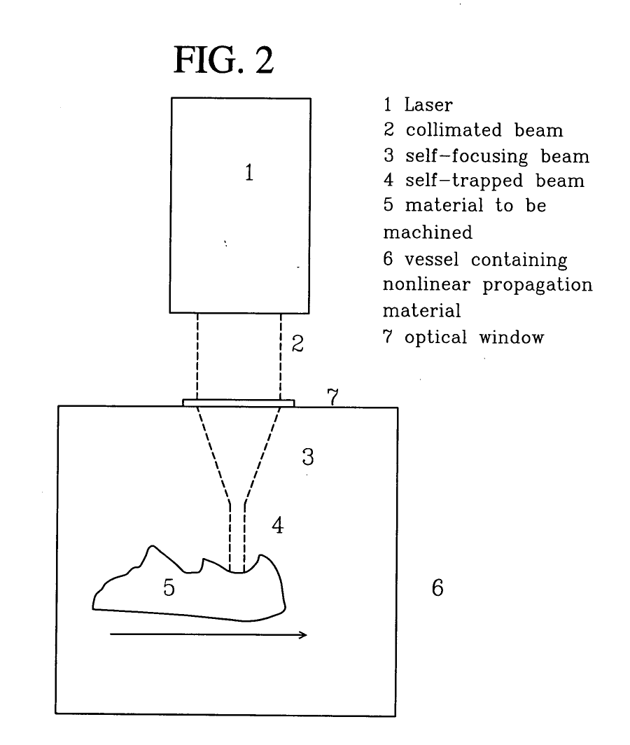

FIG. 3. Same as FIG. 2 but with an optional lens to be used in conjunction with the self-focusing to obtain better coupling in the self-trapped filament.

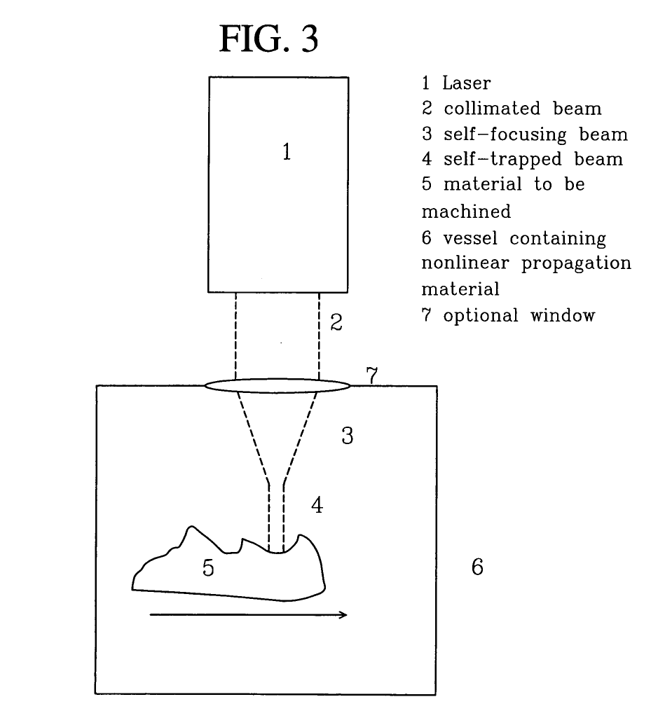

FIG. 4. Laser micromachining with self-focusing the input laser beam configured to improve the pulse quality at the point where the material is to be modified.

FIG. 5. Laser micromachining with self-focusing the input laser beam configured to maintain the pulse intensity at the point where the material is to be modified.

FIG. 6. From U.S. Pat. No. 5,656,186. Shows threshold for ablation for gold as a function of pulse width.

FIG. 7. From U.S. Pat. No. 5,984,519. Shows threshold for ablation of organic material as a function of pulse width.

FIG. 8. From Soileau. Predates FIGS. 6 & 7. Shows threshold for ablation of fused silica and NaCL as a function of pulse width.

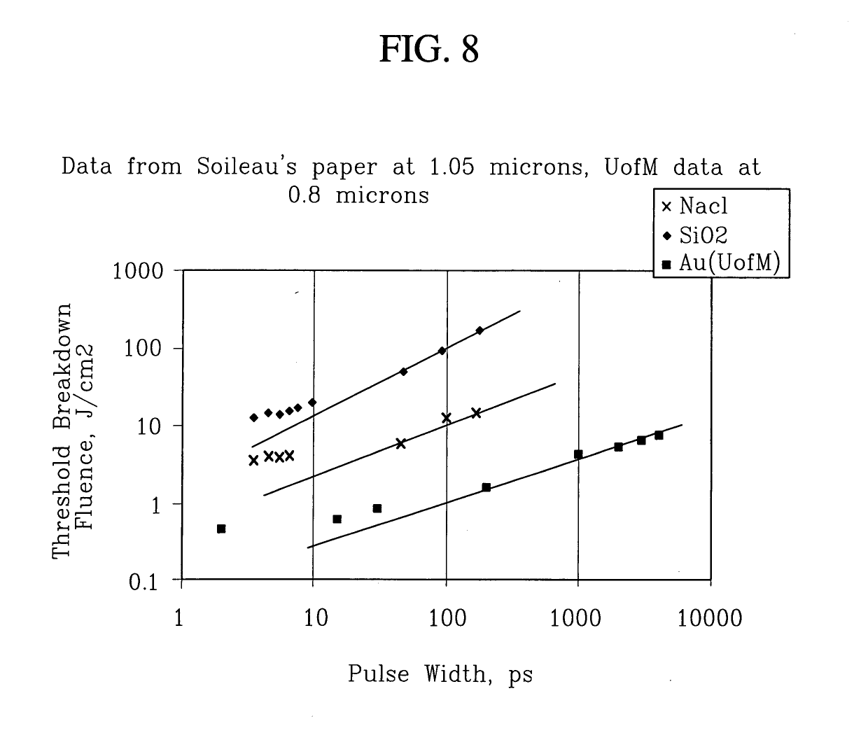

### DETAILED DESCRIPTION OF THE PREFERRED EMBODIMENT

By way of example, five preferred embodiments of the present invention are described herein. The first embodiment relates to using a gas or vapor for propagating the laser beam before the material to be micromachined where the laser wavelength is near a resonance in the vapor or gas. This case the results in self-focusing in atomic vapors where the laser wavelength is tuned close to an atomic resonance can be used to determine the properties of the self-focusing. The second embodiment relates to using a gas where the laser is far from a resonance in the gas or vapor. This would be the correct treatment where the self-focusing material is air, the components of air, noble gases and mostly any gas. In this case, ionization of the material limits the self-trapped filament diameter and the studies in self-trapping in air can be used to determine the properties of the self-focusing. The third embodiment is where the self-trapped material is a solid or liquid. In this case, for longer pulses there is no limit on the self-trapped filament diameter so the moving foci experiments better described the properties or other nonlinear phenomena limit the peak power and these processes limit the diameter of a small and constant diameter high intensity spot. The fourth and fifth embodiments do not utilize a self-trapped filament. They utilize only self-focusing for improved micromachining. An advantage is that the nonlinear material does not need to be in contact with the material to be modified. The nonlinear material utilized can be any material with a sufficiently high nonlinear refractive index including those disclosed in the first through third embodiments.

In the first embodiment the self-focusing material has a resonance that is close to the wavelength of the laser utilized for micromachining. The self-focusing material described is an atomic vapor of a metal. However, atomic vapors of metals are not well suited for the industrial setting since low pressures and high temperatures are usually needed. They are often combustible and it is difficult to keep the materials from depositing on the surrounding surfaces. A solution to this problem is a cell containing the self-focusing material that is closely coupled to the material to be machined. There are other gases and vapors that have resonances at appropriate wavelengths that are easier to handle. For example, oxygen has resonances around 787 nm. This is a wavelength that is accessible by the Ti:sapphire laser. Water vapor has resonances around 1550 nm, this is a wavelength that is accessible by an Erbium-doped fiber laser.

The initial considerations on utilizing self-trapped filaments for micromachining is to obtain the correct energy density on the surface for material processing and the correct spot size for small structure machining. In Harter there is a study on how to generate different size filaments in atomic vapors. It is shown that the filament size can be varied from 5 μm to 50 μm. This is the ideal size range for micromachining. D can be changed by varying δnₘₐₓ. This is clear from the equation above. As is described in Harter (p. 113), δnₘₐₓ is varied by changing the detuning of the laser from the resonance or by changing the partial pressure (number density) of the atomic vapor.

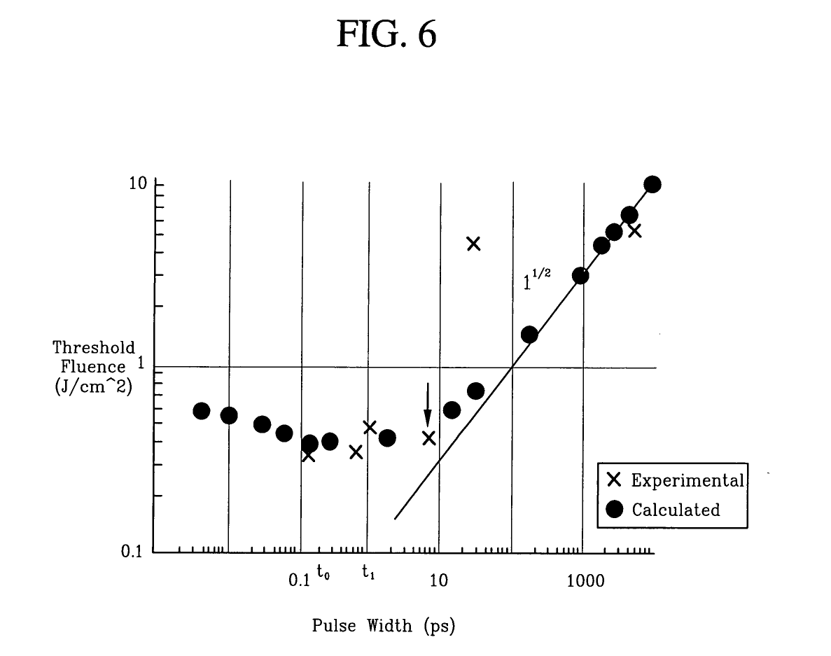

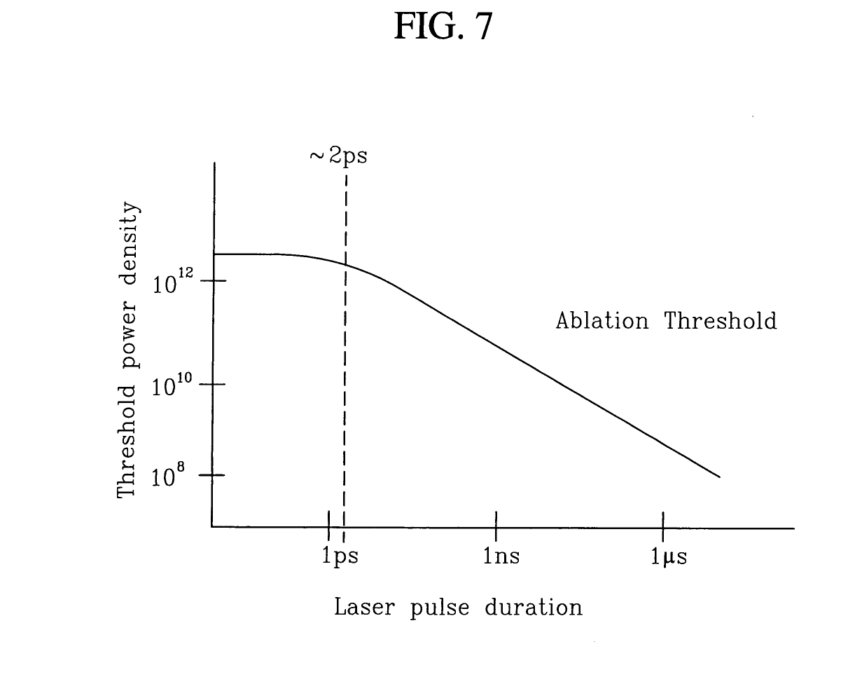

The power density in the filament in the Harter reference (p.111) is about 10⁷ Wattts/cm² (5 nanosecond pulse width). The power density (or energy density) needed for micromachining is pulse-width dependent. This is shown on the curves from patents U.S. Pat. Nos. 5,984,916 and 5,656,186 (FIGS. 6 & 7). These are essentially the same curves, however, the one in U.S. Pat. No. 5,984,916 is shown in units of power density while in U.S. Pat. No. 5,656,186 (FIG. 7) it is shown in terms of energy density. From the curve in U.S. Pat. No. 5,984916 (FIG. 6) the power density of 10⁷ Watts/cm² is not sufficient for micromachining organic material if the pulse width remained 5 ns as was used in the Harter reference. However, if the pulse width is increased to about 100 μs then this power density is sufficient. From the curve in U.S. Pat. No. 5,656,186, the energy density of 0.04 J/cm² in the Harter reference would not be sufficient to micromachine gold with a pulse width of 5 ns. However, if the pulse width is increased to about 100 μs then the energy density is sufficient for micromachining gold. Another example will be used to further illustrate how the pulse width, and the density of the material is used to optimize micromachining. For example the density of the vapor would need to be increased by a factor of 25 if a 5 μm spot is preferred over the 25 μm spot used in the previous example. The critical power decreases by 25 due to the increase in n₂. However, the area decreases by 25 so the power density remains the same in the filament. It should be noted that in atomic vapors the refractive index, nₒ, is essentially one and can be considered a constant as a function of the number density of the vapor.

It is possible to change the material properties to micromachine with shorter pulses and with the same size filament. In Harter (p. 113) it states that δn depends on the atomic number density N and the laser detuning Δ as N/Δ². Thus if we take the number density for the 25 um filament and increase it by 25 we then can increase the detuning by 5 to keep the same 25 um filament. In order to saturate the refractive index δn the power needs to increase by 25. Thus the power density has increased to 2.5×10⁸ Watts/cm². Since the threshold for micromachining is proportional to the square root of the pulse width, the required pulse width is reduced from 100 μsec to 20 μsec. A pulse width of 20 μsec is long for micromachining. A typical laser for micromachining is a Q-switched Nd:YAG laser. It has a pulse width of around 100 nanoseconds. To modify the properties of a sodium vapor so that a pulse width 3 orders of magnitude lower (100 nanosecond pulse) can be used for micromachining then the number density would need to increase by 6 orders of magnitude. This is not feasible, so other means of increasing the critical power for self-focusing while keeping the δnₘₐₓ the same as it is here for filaments with diameters between 5-100 μm is necessary. This is can be accomplished by switching to a material with a weaker resonance than this sodium resonance. Since the transition in sodium utilized for these experiments is particularly strong, there are many other possibilities for this work.

In the second embodiment the material for self-focusing the beam is replaced by a gaseous material where the laser light is far from resonance. The most common gaseous material is air. The nonlinear refractive index of air at atmospheric pressure is such that P_{cr} is about 2×10⁹ watts. Changing the laser wavelength, the pressure of the gas or the type of gas can vary this value. In Nibbering et al, “Determination of the inertial contribution to the nonlinear refractive index of air, N₂ and O₂ by use of unfocused high-intensity femtosecond laser pulses”, J. Opt. Soc. Am., B 14, pp. 650-660, 1997, which reference is hereby incorporated herein by reference as though copied verbatim herein, it is shown that the value of n₂ can be varied by an order of magnitude between the gases Ar, Xe, SF₆, N₂, O₂ and air. In Shimoji et al, “Self-focusing in pressurized air at 308 nm” in Conference on Lasers and Electro-Optics Technical Digest, Series 1988, Vol. 7, Optical Society of America, Washington, D.C., 1988 paper WM44, which reference is hereby incorporated herein by reference as though copied verbatim herein, P_{cr} is reduced by almost two orders of magnitude to 5×10⁷ Watts by increasing the pressure of air to 50 atmospheres and using a laser with a wavelength of 308 nm rather than the 800 nm wavelength used by Brun et. al. In gases that are utilized off resonance the saturation of the nonlinear refractive index is not caused by the saturation of the transition but the onset of ionization of the gas. The ionization is predominantly a multiphoton effect. Therefore, a shorter wavelength pulse will have a lower threshold. Experimentally the filament size for a laser beam at 800 nm was measured to be 80 μm while for 300 nm the filament was measured to be 380 μm.

Again, there are many different means of changing the parameters in order to get the desired results. One set of parameters that are close to ideal are those given in Brun. The self-focusing medium is atmospheric air so it is easy to use. The laser is a Ti:sapphire laser operating at 800 nm with a pulse width of 150 fs. It has been reported that ultrafast pulses at this wavelength are ideal for precision micromachining (Craig, “Ultrafast pulses promise better processing of fine structures,” Laser Focus World, pp. 79-86, September 1998, which reference is hereby incorporated herein by reference as though copied verbatim herein). The intensity density in the filament is about 10.5 J/cm² which by the curves from patents U.S. Pat. Nos. 5,984,916 and 5,656,186 are more than sufficient for micromachining gold and organic material. However, it took 10 meters to focus the spot in air, the laser pulse energy was 15 mJ and the spot size was 80 μm. It may be desired to reduce each of these properties. A method to reduce each of these parameters is to keep in mind that the mechanism for equilibrating the filament may be different than the mechanism that starts the self-focusing. Thus a different material can be used for initiating the self-focusing. A self-focusing material that has a n₂ 10 times that of atmospheric air would have a P_{cr} 1/10 that of air so 1.5 mJ would only be needed. In order to reduce the focal distance by the square root of 10, a 10 times higher n₂ can be used. The initial spot size used by Brun was 4 mm. A 400 μm initial spot size would reduce the focal length by 1/10 to one meter. If the pulse energy is reduced by 1/10 to 1.5 mj, then the spot would reduce further before ionization would equilibrate the spot size. Unlike most nonlinear materials, equilibrium would be reached with a smaller spot size since ionization is a multiphoton phenomena and the saturation is not linear with intensity. The material for initiating self-trapping can be a cell of high-pressure air or an atomic vapor. Potassium vapor has a resonance at 766.5 nm that was used for the first demonstration of self-focusing in an atomic vapor (Grischkowsky, “Self-focusing of light by potassium vapor,” Phys. Rev. Lett., Vol. 24, pp. 866-869, 1970, which reference is hereby incorporated herein by reference as though copied verbatim herein). This resonance would be suitable for use with this Ti:sapphire laser.

The formation of the self-trapped filament has an additional advantage for ultrashort lasers. Ultrashort pulses from lasers can often have pedestals or satellite pulses (for example, see U.S. Pat. No. 5,847,863, FIG. 9(b)) that are difficult to eliminate. These can be harmful for laser-matter interactions (Homoelle, “Pulse contrast enhancement of high-energy pulses by use of a gas-filled hollow waveguide,” Opt. Lett., Vol. 27, pp. 1646-1648, 2002, which reference is hereby incorporated herein by reference as though copied verbatim herein). Self-focusing will not focus the lower peak power pedestal and satellite pulses so this process will eliminate this background radiation from the pulse. Self-focusing without self-trapping can also be used for just the purpose of pulse clean up.

In Braun only about 1/10 of the initial energy of the laser beam is coupled into the self-trapped filament. In Harter (p. 120) a substantial amount of the laser energy was coupled into a single filament. However, the filament was a multi-mode filament as shown in FIG. 9.12(d). This filament was very similar to that predicted in J. J. Marbuger and E. Dawes, “Dynamical formation of a small-scale filament,” Phys. Rev. Lett., Vol. 21, p. 556, 1968, and E. L. Dawes and J. H. Marburger, “Computer studies in self-focusing,” Phys. Rev., Vol. 189, p. 862, 1968, which references are hereby incorporated herein by references as though copied verbatim herein. The reason for multi-mode filaments is due to the spherical aberration induced in the focusing process of coupling light into the self-trapped filament. This problem is very similar to our work in coupling all of the light into a single mode in a multi mode amplifier (U.S. Pat. No. 5,818,630). Thus, the methods utilized in that work can also be applied here. The simplest method is to use a lens to couple into the self-trapped filament as was used in Harter, but resulted in the spherical aberrations. Replacing the lens with a diffractive element can reduce these aberrations in generating the self-trapped filament by giving a more optimal intensity profile. One of the most promising methods would be to utilize a waveguide taper. The taper can be made of an optical fiber where the core adiabatically tapers to the diameter close to that of the self-focused filament. The core refractive index can be shaped to give good coupling of the light into the single mode of the self-trapped filament. A recent example on how this is accomplished is given in Liu, “Fiber design-from optical mode to index profile,” Opt. Eng., Vol. 42, pp. 981-984, 2003, which reference is hereby incorporated herein by reference as though copied verbatim herein. The taper could also be a hollow tube filled with a gas that could be a nonlinear material. Such a taper will have other advantages. The direction of the self-trapped filament can vary from small perturbations. Small fluctuations of the shape of the laser beam, particulates and refractive index fluctuations in the nonlinear material caused by turbulence or heat waves can all affect the direction of the self-trapped filament.

The third embodiment is to use a liquid or a solid for self-focusing and the generation of a small spot over many Rayleigh lengths. The model used for liquids and solids is that the pulse does not form a self-trapped filament but different portions of the pulse focus at different distances from the input as is described in Loy, “Small-scale filaments in liquids and tracks of moving foci,” Phys. Rev. Lett., Vol. 22, pp. 994-997, 1969, which reference is hereby incorporated herein by reference as though copied verbatim herein. In Chiao et al, “Self-trapping of Optical Beams,” Phys. Rev. Lett., Vol. 13, pp. 479-482, 1964, which reference is hereby incorporated herein by reference as though copied verbatim herein, a list is given for the nonlinear refractive index for a number of materials. Carbon disulfide has the largest n₂ and has been used to make spot sizes in the 5 μm range however, the nonlinear refractive index is too high and sufficient energy densities is not possible. The n₂ of liquids vary over orders of magnitude. In Alfano, “Direct distortion of electronic clouds of rare-gas atoms in intense electric fields,” Phys. Rev. Lett., Vol. 24 pp. 1217-1220, 1970, which reference is hereby incorporated herein by reference as though copied verbatim herein, it is shown in liquid argon that filaments of 5-20 μm are formed. The pulse energy in the filaments is approximately 1 J/cm² for a 4 picosecond pulse. This is suitable for micromachining. Liquid Argon has a n₂ of 0.6×10⁻¹³ ESU while water has a n₂ of ˜2×10⁻¹³ ESU so similar results for micromachining can be expected by using water as the self-focusing material with pulses about 4 times longer. Calcite has a nonlinear refractive index of 0.8×10⁻¹³. This number is similar to that of liquid argon. The filaments are 20 μm with pulse energies of approximately 2 J/cm² for the 4 picosecond pulses (Alfano, “Observation of self-phase modulation and small-scale filaments in crystals and glasses,” Phys Rev Lett., Vol. 24 pp. 592-594, 1970, which reference is hereby incorporated herein by reference as though copied verbatim herein). A difficulty with solid materials is that the density of the material is not a variable and cannot be varied to change the filament size. The mechanism that limits the spot size in solid and liquids is the onset of ionization as in the case with gases (Liu, “Intensity clamping of a femtosecond laser pulse in condensed matter,” Opt. Comm., Vol., 201, pp. 189-197, 2002, which reference is hereby incorporated herein by reference as though copied verbatim herein). In liquids there is more flexibility by mixing together different liquids. Again, the threshold for micromachining can be met by changing the pulse width of the laser.

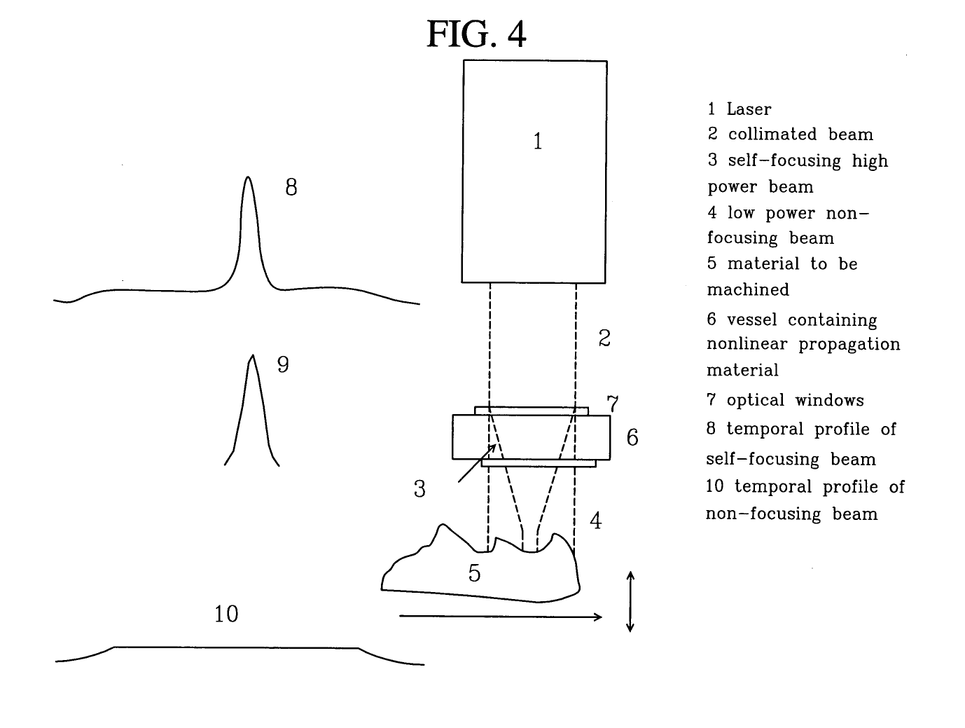

In the fourth embodiment self-focusing is utilized without the formation of a self-trapped filament. One of the main advantages of this configuration is that the nonlinear material does not need to be in contact or very close to the material being modified. Another advantage is that there does not need to be an efficient formation of a self-trapped filament in the nonlinear material. In this configuration it is possible to improve the quality of the input pulse both temporally and spatially. The mechanism for removing the low power components of the pulse is illustrated in FIG. 4. Without self-focusing the beam that is directed at the material will not ablate the material to be modified. The high power portion of the pulse is focused onto the material to be modified by self-focusing. The low power pedestal or low power satellite pulses do not get focused onto the material and do not affect the micromachining process. A lens can also be used in conjunction with the self-focusing to reduce the distance from the laser to the material to be modified. However, the lens does not focus the laser beam to the point of interaction.

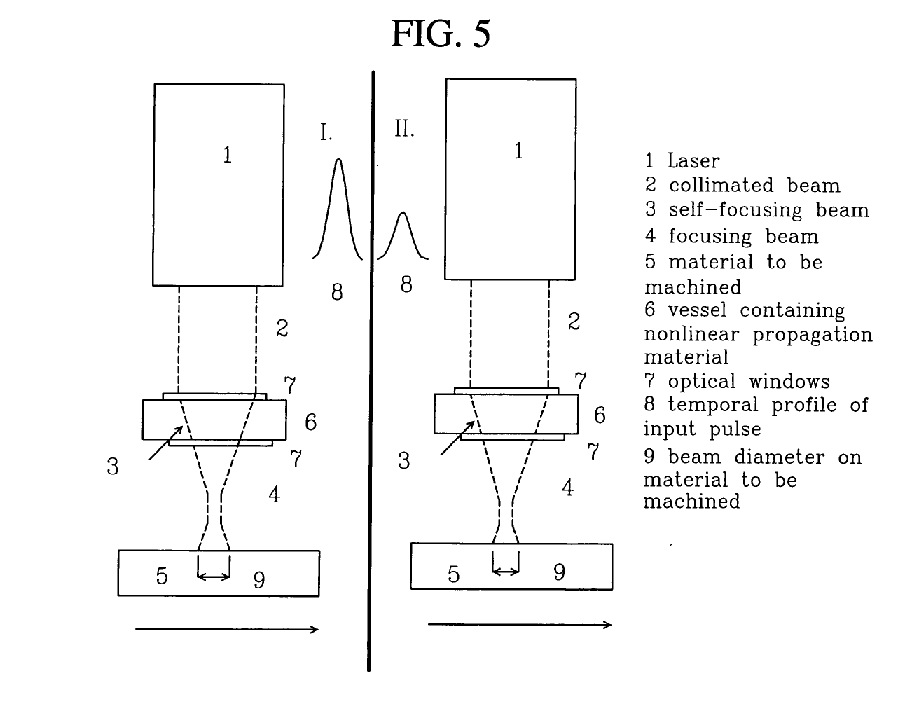

Another possible implementation utilizing self-focusing is shown in FIG. 5. In this configuration the affect of the pedestal may not corrected. However, this configuration allows for a more constant pulse energy density on the sample as the pulse energy changes from shot-to-shot. This can be important when too high of an energy density can lead to catastrophic damage. An example is a brittle material such as a glass or ceramic where too high of a laser power can lead to crack formation. In this configuration a higher peak power tends to move the focus further in front of the material so that spot size increases with peak power. In FIG. 5 case I the peak power of the pulse is about two times greater than in case II. The beam diameter on the material to be machined is about 40% greater in case I than case II. Thus, the focusing has been configured to keep the intensity constant on the material to be modified constant in spite of power instabilities of the laser.

1. A system for ablating solid material, comprising
a laser generating ultra short pulses; and
a medium which conducts said ultra short pulses toward said solid material;
wherein said ultra short pulses self focus in said medium to a power sufficient to ablate said solid material.

2. A system for ablating solid material, comprising:
a laser generating ultra short pulses; and
a medium which conducts said ultra short pulses toward said solid material;
wherein said ultra short pulses self trap in said medium at a power sufficient to ablate said solid material.

3. A method for ablating solid material, comprising:
generating ultra short laser pulses; and
self focusing said ultra short laser pulses in a medium which conducts said ultra short pulses toward said solid material, to a power sufficient to ablate said solid material.

4. A method for ablating solid material, comprising:
generating ultra short laser pulses; and
self trapping said ultra short laser pulses in a medium which conducts said ultra short pulses toward said solid material, at a power sufficient to ablate said solid material.
